(19) United States
(12) Patent Application Publication
(10) Pub. No.: US 2015/0019904 A1
(43) Pub. Date: Jan. 15, 2015

(54) DATA PROCESSING SYSTEM AND OPERATING METHOD THEREOF

(71) Applicant: SK hynix Inc., Gyeonggi-do (KR)

(72) Inventor: Sung Gun CHO, Gyeonggi-do (KR)

(73) Assignee: SK hynix Inc., Gyeonggi-do (KR)

(21) Appl. No.: 14/053,227

(22) Filed: Oct. 14, 2013

(30) Foreign Application Priority Data
Jul. 9, 2013 (KR) 10-2013-0080213

(51) Int. Cl. G06F 11/10

(52) U.S. Cl. CPC G06F 11/1048
USPC 714/6.11

(57) ABSTRACT

Provided is an operating method of a data processing system which includes a data storage device and a host device. The operating method includes reading data at the data storage device based on a request from the host device, and performing an error correction code (ECC) decoding operation on the read data, and performing an additional ECC decoding operation at the host device when the ECC decoding operation performed by the data storage device fails.

### CROSS-REFERENCES TO RELATED APPLICATION

The present application claims priority under 35 U.S.C. 119(a) to Korean application number 10-2013-0080213, filed on Jul. 9, 2013, in the Korean Intellectual Property Office, which is incorporated herein by reference in its entirety.

### BACKGROUND

1. Technical Field

Various embodiments relate to a data processing system, and more particularly, to a data processing system and an operating method for processing an error correction code (ECC) between a data storage device and a host device, which are included in the data processing system.

2. Related Art

In general, a path for transmitting information may be defined as a channel. When information is transmitted through a wired communication, a transmission line through which the information is transmitted becomes a channel. When information is transmitted through a wireless communication, air through which the information is transmitted becomes a channel.

A process in which a data storage device stores data and reads data stored therein may also be defined as a channel. In this case, time lapse from the moment at which the data storage device stores data to the moment at which the stored data is read from the data storage device may become the channel. Furthermore, a physical path through which the data storage device stores data and the stored data is read from the data storage device may become the channel.

While data are transmitted through a channel the data may be damaged with various errors. That is, while the data are transmitted through the channel, an error may occur in the data. Research has been continuously conducted on devices and methods for detecting an error occurring in data and removing the detected error to recover the original data.

For example, an error correction code (ECC) or error control code may be used to detect an error occurring in data and remove the detected error to recover the original data. A process of generating a transmission data by adding the ECC to data before the data are transmitted is referred to as an ECC encoding operation. Furthermore, a process of restoring the original data from the transmission data containing an error through the added ECC is referred to as an ECC decoding operation.

An error rate of a channel may differ depending on characteristics of the channel. As the error rate increases, the ECC encoding and decoding methods for restoring the original data may become complex, and a hardware for performing the ECC encoding and decoding methods may become complex.

### SUMMARY

Various exemplary embodiments are directed to a data processing system and an operating method for improving an error correction ability of the data processing system.

Various exemplary embodiments are directed to an ECC processing method for improving reliability of data stored in a data storage device.

In an exemplary embodiment of the present invention, there is provided an operating method of a data processing system which includes a data storage device and a host device. The operating method may include reading data at the data storage device based on a request from the host device, and performing an error correction code (ECC) decoding operation on the read data, and performing an additional ECC decoding operation at the host device when the ECC decoding operation performed by the data storage device fails.

In an exemplary embodiment of the present invention, a data processing system may include a data storage device suitable for reading data based on a request from a host device, and for performing an ECC decoding operation on the read data, and a host device suitable for performing an additional ECC decoding operation when the ECC decoding operation performed by the data storage device fails.

### BRIEF DESCRIPTION OF THE DRAWINGS

Features, aspects, and embodiments are described in conjunction with the attached drawings, in which:

FIG. 1 is a block diagram illustrating a data processing system according to an embodiment of the present invention;

FIG. 2 is a flowchart illustrating an operation of a data storage device to perform an ECC decoding operation according to an embodiment of the present invention;

FIG. 3 is a diagram for explaining an iterative decoding method of an ECC decoding algorithm according to an embodiment of the present invention;

FIG. 4 is a flowchart illustrating an operation of a data processing system to perform an ECC decoding operation according to an embodiment of the present invention;

FIG. 5 is a block diagram illustrating a data processing system according to an embodiment of the present invention;

FIG. 6 is a block diagram illustrating a data processing system according to an embodiment of the present invention;

FIG. 7 is a block diagram illustrating a data processing system according to an embodiment of the present invention; and

FIG. 8 is a block diagram illustrating an SSD controller of FIG. 7.

### DETAILED DESCRIPTION

Exemplary embodiments of the present invention will be described below in more detail with reference to the accompanying drawings. Throughout the disclosure, reference numerals correspond directly to the like numbered parts in the various figures and embodiments of the present invention. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The drawings are not necessarily to scale and in some instances, proportions may have been exaggerated in order to clearly illustrate features of the embodiments. In this specification, specific terms have been used. The terms are used to describe the present invention, and are not used to qualify the sense or limit the scope of the present invention.

In this specification, ‘and/or’ represents that one or more of components arranged before and after ‘and/or’ is included. Furthermore, ‘connected/coupled’ represents that one component is directly coupled to another component or indirectly coupled through another component. In this specification, a singular form may include a plural form as long as it is not specifically mentioned in a sentence. Furthermore, ‘include/comprise’ or ‘including/comprising’ used in the specification represents that one or more components, steps, operations, and elements exists or are added.

Hereafter, the exemplary embodiments of the present invention will be described with reference to the drawings.

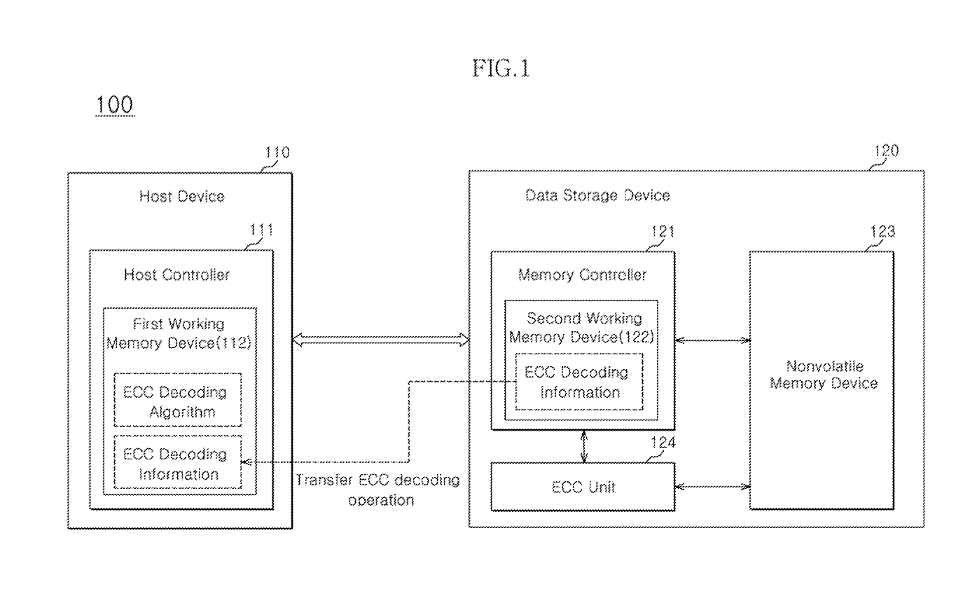

FIG. 1 is a block diagram illustrating a data processing system according to an exemplary embodiment of the present invention.

Referring to FIG. 1, the data processing system 100 includes a host device 110 and a data storage device 120.

The host device 110 may include portable electronic devices such as mobile phones, MP3 players, and lap-top computers or electronic devices such as desktop computers, game machines, TVs, beam projectors, and car entertainment systems.

The host device 110 may include a host controller 111 and a first working memory device 112. Though FIG. 1 illustrates the first working memory device 112 included in the host controller 111, the first working memory device 112 may be provided outside of the host controller 111.

The host controller 111 may control overall operations of the host device 110. When a failure of an ECC decoding operation is announced from the data storage device 120, the host controller 111 may perform an additional ECC decoding operation on data transmitted from the data storage device 120. The host controller 111 may drive firmware and/or software for controlling the overall operations of the host device 110 and the ECC decoding operation. The firmware and/or software and data required for driving the firmware and/or software may be loaded into the first working memory device 112.

The first working memory device 112 may store the firmware and/or software and the data required for the operations of the host controller 111. The first working memory device 112 may store an ECC decoding algorithm in such a form that may be driven by the host controller 111 (for example, software). When the host controller 111 performs the additional ECC decoding operation on the data transferred from the data storage device 120, the first working memory device 112 may store information required for the ECC decoding operation and transmitted from the data storage device 120 (hereafter, referred to as an ‘ECC decoding information’).

The data storage device 120 may operate based on a request from the host device 110. The data storage device 120 may store data accessed by the host device 110. That is, the data storage device 120 may be used as a main storage device or auxiliary memory device of the host device 110. The data storage device 120 may be referred to as a memory system.

The data storage device 120 may include memory controller 121, a second working memory device 122, a nonvolatile memory device 123, and an ECC unit 124. Though FIG. 1 illustrates the second working memory device 122 included in the memory controller 121, the second working memory device 122 may be provided outside of the memory controller 121.

The memory controller 121, the second working memory device 122, the nonvolatile memory device 123, and the ECC unit 124 may be implemented with a memory card or solid state drive (SSD). The memory card and the SSD may be coupled to the host device 110 through various interfaces.

The memory controller 121 may control overall operations of the data storage device 120. The memory controller 121 may drive firmware and/or software for controlling the overall operations of the data storage device 120. The firmware and/or software and data required for driving the firmware and/or software may be loaded into the second working memory device 122.

The second working memory device 122 may store the firmware and/or software and data required for the operation of the memory controller 121. The second working memory device 122 may store the ECC decoding information that is information required for an ECC decoding operation of the ECC unit 124. Further the second working memory device 122 may temporarily store data that are to be transmitted from the host device 110 to the nonvolatile memory device 123 or from the nonvolatile memory device 123 to the host device 110. That is, the second working memory device 122 may operate as a buffer memory device or cache memory device.

The memory controller 121 may control the nonvolatile memory device 123 based on the request from the host device 110. For example, the memory controller 121 may provide data read from the nonvolatile memory device 123 to the host device 110. For another example, the memory controller 121 may store data transferred from the host device 110 in the nonvolatile memory device 123. For those operations, the memory controller 121 may control read, program (or write), and erase operations of the nonvolatile memory device 123.

The nonvolatile memory device 123 may serve as a storage medium of the data storage device 120. The nonvolatile memory device 123 may include various types of nonvolatile memory devices such as a NAND flash memory device, a NOR flash memory device, a ferroelectric random access memory (FRAM), a magnetic RAM (MRAM) using a tunneling magneto-resistive (TMR) layer, a phase change memory device (PRAM) using chalcogenide alloys, a resistive memory device (ReRAM) using transition metal oxide, and the like. The nonvolatile memory device 123 may be implemented with a combination of a NAND flash memory device and the above-described various types of nonvolatile memory devices.

The ECC unit 124 may detect and correct errors in data read from the nonvolatile memory device 123. The ECC unit 124 may be implemented in a form of hardware or software. Alternatively, the ECC unit 124 may be implemented in a combination of hardware and software.

The ECC unit 124 may perform an ECC encoding operation on data to be stored in the nonvolatile memory device 123. For example, the ECC unit 124 may perform an arithmetic operation based on an ECC encoding algorithm on the data to be stored in the nonvolatile memory device 123, and generate parity data. The ECC unit 124 may perform an ECC decoding operation on data read from the nonvolatile memory device 123 and the parity data. For example, the ECC unit 124 may perform an arithmetic operation based on an ECC decoding algorithm on the data read from the nonvolatile memory device 123 and the parity data, may detect errors contained in the read data, and may correct the detected errors.

As the encoding and decoding algorithms of the ECC unit 124, a soft-decision-based ECC algorithm may be used. For example, an ECC algorithm capable of repeating an ECC operation, such as a low density parity check (LDPC) code or turbo code, may be used as the encoding and decoding algorithms of the ECC unit 124.

When the number of errors contained in the data read from the nonvolatile memory device 123 exceeds an error correction ability of the ECC unit 124, the ECC unit 124 may repeat the ECC decoding operation based on an iterative decoding method. That is, when the ECC decoding operation fails, the ECC unit 124 may repeat the ECC decoding operation until the ECC decoding operation become successful. The ECC unit 124 may repeat the ECC decoding operation until it reaches a maximum repetition number.

In case where the ECC decoding operation does not become successful even though the ECC decoding operation was repeated until the maximum repetition number, the data storage device 120 may announce the failure of the ECC decoding operation to the host device 110, and provide the ECC decoding information to the host device 110 so that an additional ECC decoding operation is performed by the host device 110.

The host device 110 may perform the additional ECC decoding operation on the data, in which the ECC decoding operation of the data storage device 120 failed based on the provided ECC decoding information. The host device 110 may perform the additional ECC decoding operation using substantially the same ECC decoding algorithm as the ECC decoding algorithm performed by the ECC unit 124 of the data storage device 120, or an ECC decoding algorithm including additional functions. For those operations, the same ECC decoding algorithm as the ECC decoding algorithm performed by the ECC unit 124 of the data storage device 120 may be stored in the first working memory device 112 of the host device 110. Alternatively, an ECC decoding algorithm including additional functions in comparison to the ECC decoding algorithm performed by the ECC unit 124 of the data storage device 120 may be stored in the first working memory device 112 of the host device 110.

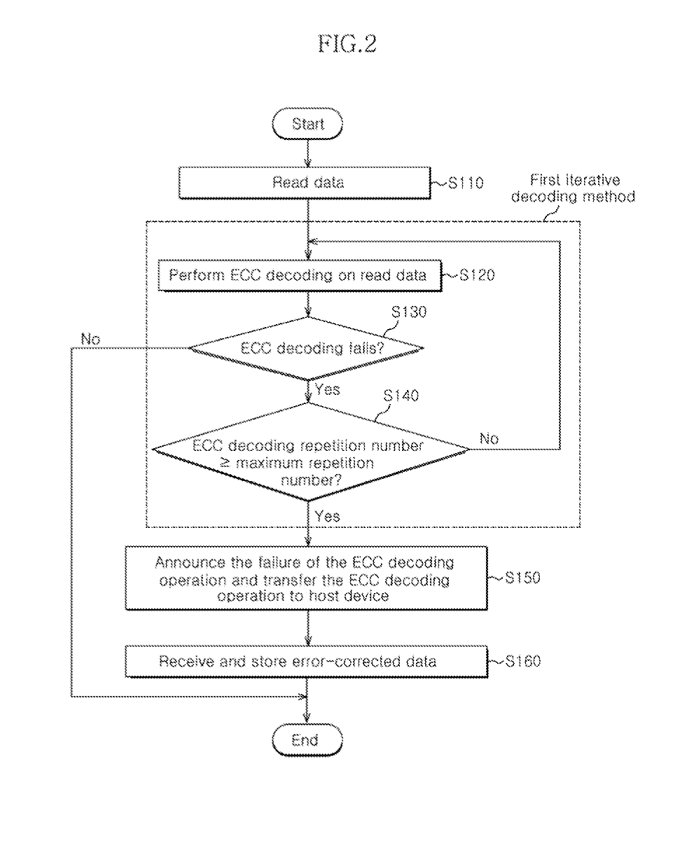

FIG. 2 is a flowchart illustrating an operation of the data storage device to perform an ECC decoding operation according to an exemplary embodiment of the present invention.

Hereinafter, referring to FIGS. 1 and 2, the ECC decoding operation of the data storage device to manage repetitive ECC decoding failures will be described.

At step S110, the data storage device 120 may read data from the nonvolatile memory device 123. In order to read data, the memory controller 121 of the data storage device 120 may provide a series of commands and addresses for reading the data to the nonvolatile memory device 123.

At step S120, the ECC unit 124 of the data storage device 120 may perform an ECC decoding operation on the data read from the nonvolatile memory device 123. The ECC unit 124 may perform the ECC decoding operation in a reverse order of an ECC encoding operation. The ECC unit 124 may perform the ECC decoding operation on the read data using parity data generated during the ECC encoding operation.

At step S130, the ECC unit 124 of the data storage device 120 may determine whether the ECC decoding operation failed or not. That is, the ECC unit 124 may determine whether or not the number of errors contained in the read data deviates from the error correction ability. When the ECC decoding operation succeeds, that is, when the errors contained in the read data are successfully corrected, the ECC unit 124 may terminate the ECC decoding operation. On the other hand, when the ECC decoding operation fails, that is, when the errors contained in the read data are not successfully corrected, the procedure proceeds to step S140.

At step S140, the ECC unit 124 of the data storage device 120 may determine whether or not the ECC decoding operation was repeated until the maximum repetition number or more. When the ECC decoding operation was not performed until the maximum repetition number, the ECC unit 124 may repeat the ECC decoding operation based on the iterative decoding method. On the other hand, when the ECC decoding operation fails even after the ECC decoding operation was performed for the maximum repetition number, the procedure proceeds to step S150.

At step S150, the data storage device 120 may announce the failure of the ECC decoding operation and transfer the ECC decoding operation to the host device 110, and provide data on which the ECC decoding operation is to be performed and the parity data corresponding to the data to the host device 110 so that an additional ECC decoding operation is performed by the host device 110. Furthermore, the data storage device 120 may provide the ECC decoding information to the host device 110 so that the ECC decoding operation is performed by the host device 110.

The ECC decoding information may include information required for driving the ECC decoding algorithm. The ECC decoding information may include additional information required when the ECC decoding operation is repeated by the host device 110, that is, when the iterative decoding method is performed by the host device 110. The additional information may include information required when an ECC decoding algorithm including additional functions is performed by the host device 110. For example, the additional information may include data stored in a memory cell adjacent to a memory cell storing data on which the ECC decoding operation is to be performed.

When the additional ECC decoding operation is successfully performed by the host device 110, that is, when errors contained in the read data are successfully corrected, the host device 110 may provide the error-corrected data to the data storage device 120. At step 160, when the error-corrected data are transmitted from the host device 110, the data storage device 120 may receive and store the error-corrected data.

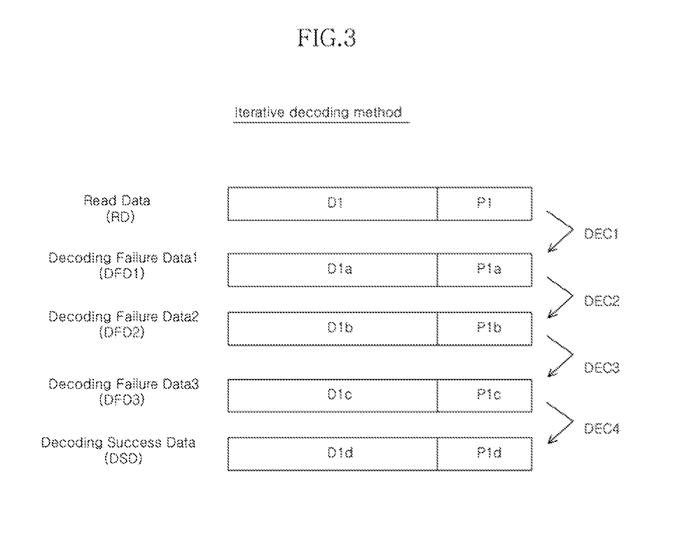

FIG. 3 is a diagram for explaining an iterative decoding method of the ECC decoding algorithm according to an exemplary embodiment of the present invention. As described above, when the soft-decision-based ECC algorithm, such as the LDPC code or turbo code, is used as the ECC decoding algorithm, an ECC decoding operation may be repeated in case where the ECC decoding operation fails.

Referring to FIG. 3, when a first ECC decoding operation DEC1 for read data RD containing h errors (h≧L, where L is the number of correctable errors) fails, a second ECC decoding operation DEC2 for first failed data DFD1 containing i errors (i≧L) may be performed. Furthermore, when the second ECC decoding operation DEC2 fails, a third ECC decoding operation DEC3 for second failed data DFD2 containing j errors (j≧L) may be performed. Furthermore, when the third ECC decoding operation DEC3 fails, a fourth ECC decoding operation DEC4 for third failed data DFD3 containing k errors (k≧L) may be performed. When the fourth ECC decoding operation DEC4 may succeed, error-corrected data DSD may be acquired. Though FIG. 3 illustrates a case in which errors contained in the read data RD are corrected as the error-corrected data DSD after the four ECC decoding operations are repeated, the number of ECC decoding operations to be repeated may be set based on the number of errors contained in the read data RD. The iterative decoding method of the ECC decoding algorithm may be performed for the maximum repetition number.

As described above, the soft-decision-based ECC algorithm, such as the LDPC code or turbo code, is characterized in that the number of errors detected from read data is varied whenever an ECC decoding operation is repeated. For this reason, when the ECC decoding operation is repeated, the number of detected errors may become smaller than the error correction ability, that is, the number of correctable errors. In this case, the detected errors may be corrected. When an ECC decoding algorithm including additional detailed functions is applied even though the same type of ECC decoding algorithms are performed, the number of detected errors may be reduced more quickly or more efficiently. For example, in the case of the LDPC code, the number of detected errors may be reduced more quickly or more efficiently when an algorithm, such as a boosting algorithm or post-processing algorithm, is added to the ECC decoding algorithm.

When the ECC decoding operation fails even though the ECC decoding operation was repeated for the maximum repetition number, a failure of the ECC decoding operation is announced from the data storage device 120 to the host device 110. At this time, ECC decoding information, data on which the ECC decoding operation is to be performed, and parity data corresponding to the data may be provided to the host device 110. For example, the data and the parity data corresponding to the data may correspond to read data RD including data D1 and parity data P1 corresponding to the data D1. For another example, the data and the parity data corresponding to the data may correspond to any one of data DFD1, DFD2, and DFD3 in which the ECC decoding operations DEC1, DEC2, and DEC3 failed.

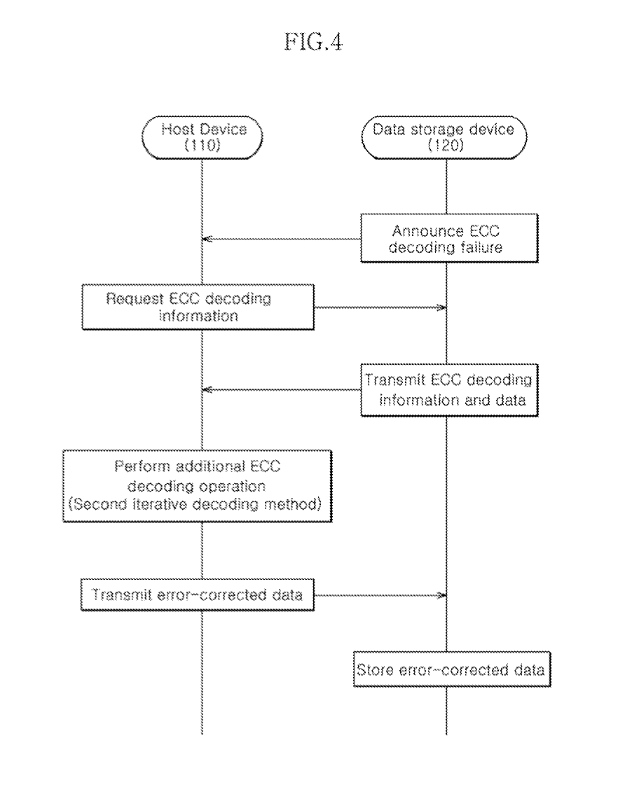

FIG. 4 is a flowchart illustrating an operation of the data processing system to perform an ECC decoding operation according to an embodiment of the present invention.

Referring to FIG. 4, a procedure that the host device 110 performs an additional ECC decoding operation after an ECC decoding operation in the data storage device 120 fails, is explained.

When the ECC decoding operation in the data storage device 120 fails, the data storage device 120 may announce a failure of the ECC decoding operation (Hereinafter, referred to as an ‘ECC decoding failure’) to the host device 110. For example, the data storage device 120 may transmit an interrupt signal denoting the ECC decoding failure. For another example, the data storage device 120 may transmit state information denoting the ECC decoding failure.

The host device 110 may request ECC decoding information from the data storage device 120 based on the ECC decoding failure. For example, the host device 110 may request the ECC decoding information immediately or in a predetermined time depending on a workload thereof.

The data storage device 120 may transmit the ECC decoding information and data to the host device 110 based on the request. As described above, the ECC decoding information may include information required for driving the ECC decoding algorithm. The ECC decoding information may include additional information required when the ECC decoding operation is repeated by the host device 110, that is, when the iterative decoding method is performed by the host device 110.

The host device 110 may perform an additional ECC decoding operation on the transmitted data. The host device 110 may perform the additional ECC decoding operation with additional functions (for example, a second iterative decoding method) in comparison to the ECC decoding operation performed by the data storage device 120 (for example, the first iterative decoding method of FIG. 2). For example, when the host device 110 performs the additional ECC decoding operation with an additional function by using ECC decoding information provided from the data storage device 120, for example, additional information required when the iterative decoding method is performed. For this reason, the host device 110 may accurately perform the additional ECC decoding operation compared to the ECC decoding operation performed by the data storage device 120, and may correct errors which were not corrected by the data storage device 120.

When the additional ECC decoding operation succeeds, the host device 110 may transmit the error-corrected data to the data storage device 120. The data storage device 120 may store the error-corrected data in place of the read data.

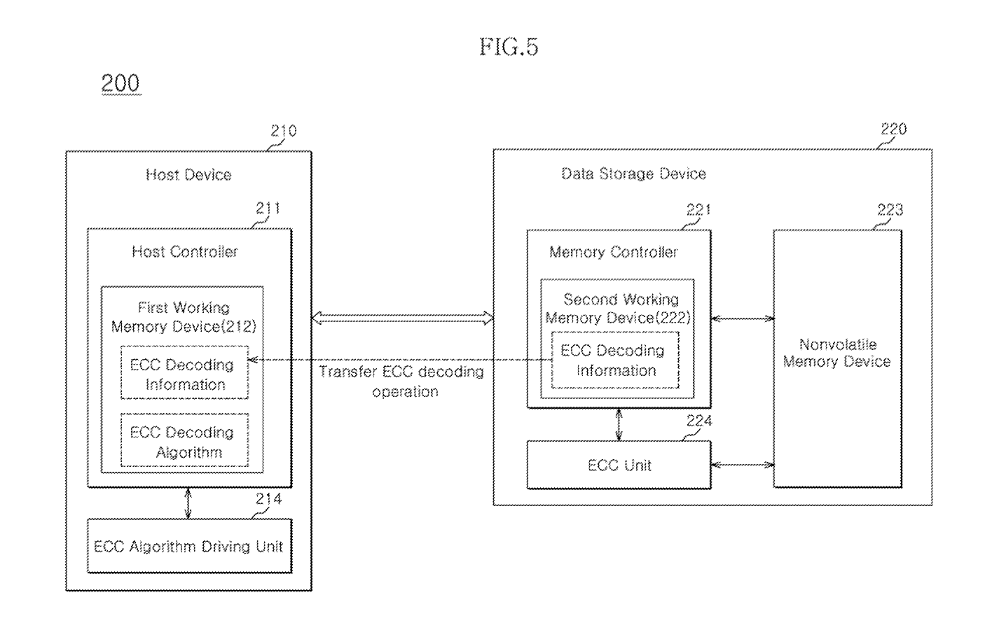

FIG. 5 is a block diagram illustrating a data processing system according to an embodiment of the present invention.

Referring to FIG. 5, the data processing system 200 may include a host device 210 and a data storage device 220.

The host device 210 may include a host controller 211, a first memory device 212, and an ECC algorithm driving unit 214. Though FIG. 5 illustrates the first memory device 212 included in the host controller 211, the first memory device 212 may be provided outside of the host controller 211.

The host controller 211 may control overall operations of the host device 210. The host controller 211 may drive firmware and/or software for controlling the overall operations of the host device 210. The firmware and/or software and data required for driving the firmware and/or software may be loaded into the first memory device 212.

The first memory device 212 may store the firmware and/or software and the data required for the operations of the host controller 211. The first memory device 212 may store an ECC decoding algorithm in such a form that may be driven by the host controller 211 (for example, software). When a failure of an ECC decoding operation is announced from the data storage device 220, the first memory device 212 may store information required for the ECC decoding operation, that is, ECC decoding information.

When the failure is announced from the data storage device 220, the host controller 211 may control the first memory device 212 and the ECC algorithm driving unit 214 so that the additional ECC decoding operation is performed on the data transmitted from the data storage device 220. That is, when the failure of the ECC decoding operation is announced from the data storage device 220, the ECC algorithm driving unit 214 may perform the additional ECC decoding operation based on the ECC decoding algorithm and the ECC decoding information, which are stored in the first memory device 212. The ECC algorithm driving unit 214 may include a hardware device, such as a processing unit, micro control unit (MCU), or controller, which is capable of driving an ECC decoding algorithm implemented in software.

Except that the ECC decoding algorithm stored in the firs memory device 212 is driven through the ECC algorithm driving unit 214, the host device 210 and the data storage device 220 may have substantially the same configuration and operation as the host device 110 and the data storage device 120 of FIG. 1. Thus, the detailed descriptions thereof may be omitted for convenience of explanation.

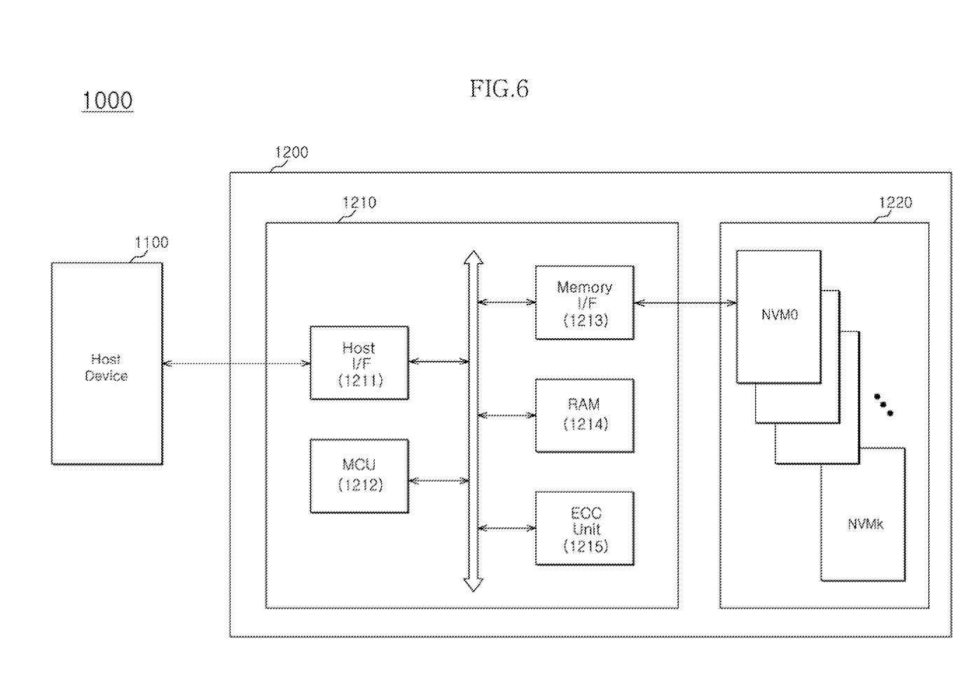

FIG. 6 is a block diagram illustrating a data processing system according to an embodiment of the present invention.

Referring to FIG. 6, the data processing system 1000 may include a host device 1100 and a data storage device 1200. When an ECC decoding operation fails even though the data storage device 1200 performs the ECC decoding operation until a maximum repetition number, the host device 1100 may perform an additional ECC decoding operation on data transmitted from the data storage device 1200. Thus, the data reliability of the data processing system 1000 may be improved.

The data storage device 1200 includes a memory controller 1210 and a nonvolatile memory device 1220. The data storage device 1200 may be coupled to the host device 1100, such as a desktop computer, a notebook computer, a mobile phone, an MP3 player, or a game machine. The data storage device 1200 is also referred to as a memory system.

The memory controller 1210 is configured to access the nonvolatile memory device 1220 in response to a request from the host device 1100. For example, the memory controller 1210 may control a read, program, or erase operation of the nonvolatile memory device 1220. The memory controller 1210 may drive firmware for controlling the nonvolatile memory device 1220.

The memory controller 1210 may include a host interface 1211, a micro control unit 1212, a memory interface 1213, a RAM 1214, and an ECC unit 1215.

The micro control unit 1212 is configured to control overall operations of the memory controller 1210 in response to a request from the host device 1100. The RAM 1214 may be used as a memory of the micro control unit 1212. The RAM 1214 may temporarily store data read from the nonvolatile memory device 1220 or data provided from the host device 1100.

The host interface 1211 may interface the host device 1100 with the memory controller 1210. For example, the host interface 1211 may communicate with the host device 1100 through one of various interface protocols such as a USB (Universal Serial Bus) protocol, a MMC (Multimedia Card) protocol, a PCI (Peripheral Component Interconnection) protocol, a PCI-E (PCI-Express) protocol, a PATA (Parallel Advanced Technology Attachment) protocol, a SATA (Serial ATA) protocol, an SCSI (Small Computer System Interface) protocol, a SAS (Serial Attached SCSI) protocol, and an IDE (Integrated Drive Electronics) protocol.

The memory interface 1213 may interface the memory controller 1210 with the nonvolatile memory device 1220. The memory interface 1213 may provide a command and address to the nonvolatile memory device 1220. Furthermore, the memory interface 1213 may exchange data with the nonvolatile memory device 1220.

The ECC unit 1215 may detect errors of the data read from the nonvolatile memory device 1220. Furthermore, the ECC unit 1215 may correct the detected errors, when the number of detected errors falls within an, error correctable range. The ECC unit 1215 may be provided inside or outside the memory controller 1210 depending on the memory system 1000.

The memory controller 1210 and the nonvolatile memory device 1220 may be integrated into one semiconductor device to form a memory device. For example, the memory controller 1210 and the nonvolatile memory device 1220 may be integrated into one semiconductor device to form a PCMCIA (personal computer memory card international association) card, a CF (compact flash) card, a smart media card, a memory stick, a multi-media card (MMC, RS-MMC, or MMC-micro), an SD (secure digital) card (SD, Mini-SD, or Micro-SD) or a UFS (universal flash storage card.

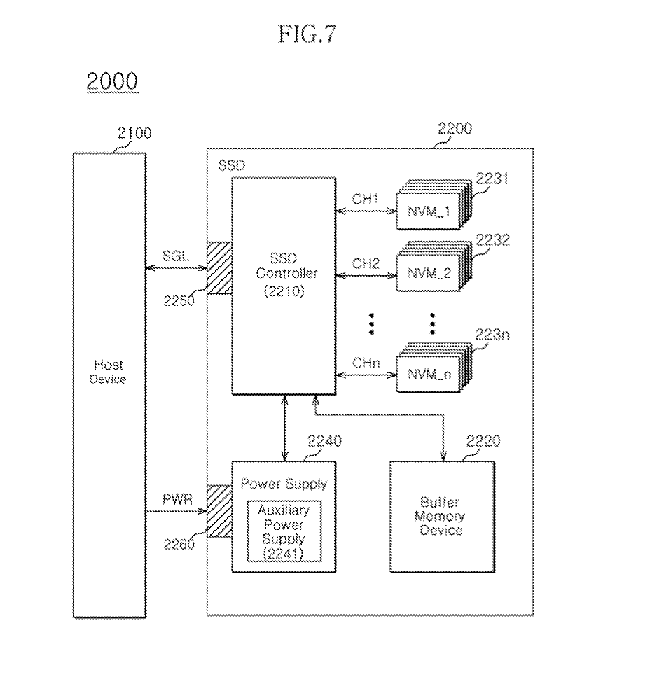

FIG. 7 is a block diagram illustrating a data processing system according to an embodiment of the present invention.

Referring to FIG. 7, the data processing system 2000 includes a host device 2100 and an SSD 2200. When an ECC decoding operation fails even though the SSD 2200 performs the ECC decoding operation until a maximum repetition number, the host device 2100 may perform an additional ECC decoding operation on data transmitted from the SSD 2200. Thus, the data reliability of the data processing system 2000 may be improved.

The SSD 2200 may include an SSD controller 2210, a buffer memory device 2220, a plurality of nonvolatile memory devices 2231 to 223n, a power supply 2240, a signal connector 2250, and a power connector 2260.

The SSD 2200 may operate in response to a request from the host device 2100. That is, the SSD controller 2210 may access the nonvolatile memory devices 2231 to 223n in response to a request from the host device 2100. For example, the SSD controller 2210 may control read, program, and erase operations of the nonvolatile memory devices 2231 to 223n.

The buffer memory device 2220 may temporarily store data, which are to be stored in the nonvolatile memory devices 2231 to 223n. Furthermore, the buffer memory device 2220 may temporarily store data read from the nonvolatile memory devices 2231 to 223n. The data temporarily stored in the buffer memory device 2220 may be transmitted to the host device 2100 or the nonvolatile memory devices 2231 to 223n under the control of the SSD controller 2210.

The nonvolatile memory devices 2231 to 223n may be used as storage media of the SSD 2200. The respective nonvolatile memory devices 2231 to 223n may be coupled to the SSD controller 2210 through a plurality of channels CH1 to CHn. One channel may be coupled to one or more nonvolatile memory devices. The nonvolatile memory devices coupled to one channel may be connected to the same signal bus and data bus.

The power supply 2240 may provide a power PWR inputted through the power connector 2260 to the SSD 2200. The power supply 2240 includes an auxiliary power supply 2241. The auxiliary power supply 2241 may supply an auxiliary power to normally terminate the SSD 2200 when a sudden power-off occurs. The auxiliary power supply 2241 may include super capacitors capable of storing the power PWR.

The SSD controller 2210 may exchange signals SGL with the host device 2100 through the signal connector 2250. The signals SGL may include commands, addresses, data and the like. The signal connector 2250 may include a connector such as PATA (Parallel Advanced Technology Attachment), SATA (Serial Advanced Technology Attachment), SCSI (Small Computer System Interface), or SAS (Serial Attached SCSI), according to the interface method between the host device 2100 and the SSD 2200.

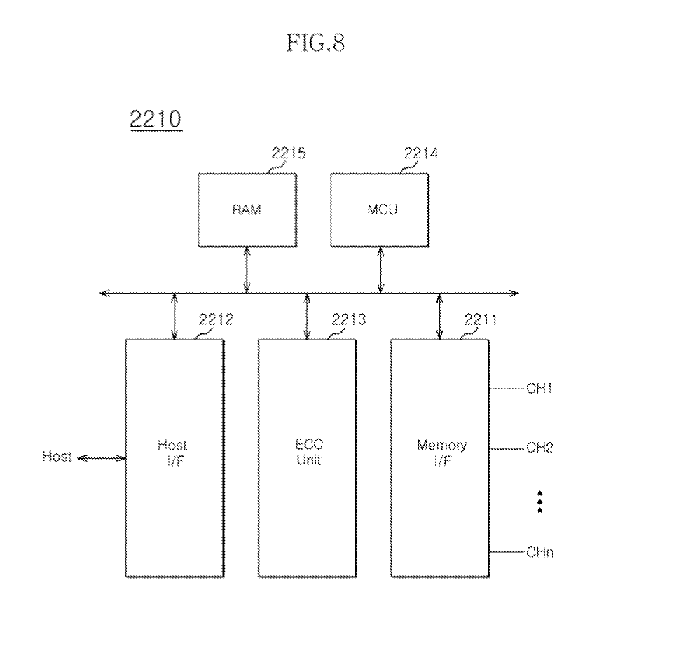

FIG. 8 is a block diagram illustrating the SSD controller 2210 of FIG. 7.

Referring to FIG. 8, the SSD controller 2210 includes a memory interface 2211, a host interface 2212, an ECC unit 2213, a micro control unit 2214, and a RAM 2215.

The memory interface 2211 may provide a command and address to the nonvolatile memory devices 2231 to 223n. Furthermore, the memory interface 2211 may exchange data with the nonvolatile memory devices 2231 to 223n. The memory interface 2211 may scatter data transmitted from the buffer memory device 2220 over the respective channels CH1 to CHn, under the control of the micro control unit 2214. Furthermore, the memory interface 2211 may transmit data read from the nonvolatile memory devices 2231 to 223n to the buffer memory device 2220, under the control of the micro control unit 2214.

The host interface 2212 may interface the SSD 2200 with the host device 2100 in response to the protocol of the host device 2100. For example, the host interface 2212 may communicate with the host device 2100 through one of PATA (Parallel Advanced Technology Attachment), SATA (Serial Advanced Technology Attachment), SCSI (Small Computer System Interface), SAS (Serial Attached SCSI) protocols. Furthermore, the host interface 2212 may perform a disk emulation function of supporting the host device 2100 to recognize the SSD 2200 as a hard disk drive (HDD).

The ECC unit 2213 may generate parity bits based on the data transmitted to the nonvolatile memory devices 2231 to 223n. The generated parity bits may be stored in spare areas of the nonvolatile memory devices 2231 to 223n. The ECC unit 2213 may detect errors of data read from the nonvolatile memory devices 2231 to 223n. When the number of detected errors falls within an error correctable range, the ECC unit 2213 may correct the detected errors.

The micro control unit 2214 may analyze and process the signal SGL inputted from the host device 2100. The micro control unit 2214 may control overall operations of the SSD controller 2210 in response to a request from the host device 2100. The micro control unit 2214 may control the operations of the buffer memory device 2220 and the nonvolatile memory devices 2231 to 223n based on firmware for driving the SSD 2200. The RAM 2215 may be used as a memory device for driving the firmware.

While certain embodiments have been described above, it will be understood to those skilled in the art that the embodiments described are by way of example only. Accordingly, the data processing system described herein should not be limited based on the described embodiments. Rather, the data processing system described herein should only be limited in light of the claims that follow when taken in conjunction with the above description and accompanying drawings.

What is claimed is:

1. An operating method of a data processing system which includes a data storage device and a host device, the operating method comprising:
reading data at the data storage device based on a request from the host device, and performing an error correction code (KC) decoding operation on the read data; and
performing an additional ECC decoding operation at the host device when the ECC decoding operation performed by the data storage device fails.

2. The operating method according to claim 1, further comprising:
determining whether or not the ECC decoding operation of the data storage device is performed until a maximum repetition number.

3. The operating method according to claim 2, wherein when the ECC decoding operation fails after the ECC decoding operation is performed until the maximum repetition number or more, the host device performs the additional ECC decoding operation.

4. The operating method according to claim 2, wherein the ECC decoding operation on the read data is repeated until the maximum repetition number.

5. The operating method according to claim 1, wherein the performing an additional ECC decoding operation comprises:
announcing a failure of the ECC decoding operation to the host device from the data storage device; and
providing information required for the ECC decoding operation and target data, on which the additional ECC decoding operation is to be performed, to the host device from the data storage device.

6. The operating method according to claim 5, wherein the target data comprises the read data.

7. The operating method according to claim 5, wherein the target data comprises data in which the ECC decoding operation by the data storage device failed.

8. The operating method according to claim 5, wherein the additional ECC decoding operation is performed on the target data based on the information required for the ECC decoding operation.

9. The operating method according to claim 8, wherein the additional ECC decoding operation is repeatedly performed on the target data.

10. The operating method according to claim 8, further comprising:
providing error-corrected data to the data storage device from the host device when the additional ECC decoding operation on the target data succeeds.

11. The operating method according to claim 10, further comprising:
storing the error-corrected data in the data storage device.

12. The operating method according to claim 1, wherein the ECC decoding operation and the additional ECC decoding operation are performed according to an error correction algorithm of a low density parity check (LDPC) code or a turbo code.

13. The operating method according to claim 1, further comprising:
determining whether the ECC decoding operation performed by the data storage device failed or not.

14. A data processing system comprising:
a data storage device suitable for reading data based on a request from a host device, and for performing an ECC decoding operation on the read data; and
a host device suitable for performing an additional ECC decoding operation when the ECC decoding operation performed by the data storage device fails.

15. The data processing system according to claim 14, wherein the data storage device comprises:
a nonvolatile memory device;
an ECC unit suitable for performing the ECC decoding operation on data read from the nonvolatile memory device;
a first working memory device suitable for storing information required for the ECC decoding operation; and
a first controller suitable for announcing a failure of the ECC decoding operation to the host device when the ECC decoding operation fails.

16. The data processing system according to claim 15, wherein the first controller provides the information stored in the first working memory device and target data, on which the additional ECC decoding operation is to be performed, to the host device when the first controller announces the failure to the host device.

17. The data processing system according to claim 15, wherein the ECC unit repeats the ECC decoding operation on the read data until a maximum repetition number.

18. The data processing system according to claim 15, wherein the ECC unit performs the ECC decoding operation according to an error correction algorithm of a low density parity check (LDPC) code or a turbo code.

19. The data processing system according to claim 14, wherein the host device comprises:
a second working memory device suitable for storing information required for the additional ECC decoding operation; and
a second controller suitable for performing the additional ECC decoding operation based on the information stored in the second working memory device.

20. The data processing system according to claim 17, wherein the second working memory device stores an ECC algorithm to perform the additional ECC decoding operation.
